(19) United States
(12) Patent Application Publication
(10) Pub. No.: US 2007/0188521 A1
(43) Pub. Date: Aug. 16, 2007

(54) METHOD AND APPARATUS FOR THREE DIMENSIONAL BLENDING

(76) Inventor: Steven D. Miller, Salinas, CA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/535,768

(22) Filed: Sep. 27, 2006

Related U.S. Application Data
(60) Provisional application No. 60/774,806, filed on Feb. 15, 2006.

(51) Int. Cl. G09G 5/00

(52) U.S. Cl. 345/629

(57) ABSTRACT

The present invention uses a dynamic transparency scheme to vertically blend a first layer of data onto a second layer of data and then horizontally merge multiple such “stacks.” For example, the present invention provided a satellite image wherein the transparency of the cloud formations dynamically changes and therefore provides a more accurate image of the cloud transparency based on its size and composition. The invention additionally provides for horizontal blending. The present invention provided a realistic day to night transition that is currently unavailable to previous systems. It should be understood that the present invention provides not only static images, but also moving images, for example, in a video. The present invention was used to produce a video that displayed a daytime-to-nighttime transition complete with cloud movement with realistic transparency. The blending at the day to night transition resulted in a hybrid satellite cloud image in this region—partially thermal infrared, and partially visible sunlight reflection.

### CROSS-REFERENCE TO RELATED APPLICATIONS

The present application claims the benefit of U.S. Provisional Application No. 60/774,806, filed Feb. 15, 2006, the entire disclosure of which is incorporated herein by reference.

### FIELD OF THE INVENTION

This invention relates in general to the field of data visualization and in particular to the field of imagery manipulation by way of transparency modification.

### BACKGROUND OF THE INVENTION

Previous techniques used to blend layers of two-dimensional image data included vertically blending layers of image data using a variety of methods. Some previous techniques include a simple overlap of multiple types of data without the use of any transparency. For example, techniques wherein a lower layer, usually the background, is substituted for an upper layer when the upper layer falls below a critical threshold value. Some previous techniques employed imaging schemes using a static transparency, wherein a first type of data (or portion thereof) is partially transparent so as to enable the viewer to see a second type of data residing below the first type of data. In these prior systems, the static transparency was unchanging and constant over the entire image.

Other imaging systems implemented a form of dynamic transparency—transparency that is not constant over the entire image. Slightly more sophisticated data blending systems examined the values of the red/green/blue (RGB) components for each layer and selected the maximum value for each component. This achieves a pseudo-blending when the relative magnitudes of the two layers vary across RGB-space, but this can also lead to unusual color effects in situations when the background dominates only one of the components and large regions where no transparency is evident. The most recent development in vertical blending involves using a transparency factor that is determined by the magnitude of the foreground dataset itself. This transparency factor is then applied to the foreground dataset, allowing the background dataset to be visible to varying degrees.

However, previous vertical blending imaging systems do not provide a method to vertically blend more than two layers of image data, and these systems do not generalize a technique to accommodate an arbitrary number of layers of image data. Some previous imaging systems do include horizontally blending layers of image data. However, these imaging systems do not include a method for vertically blending a first set of layers of image data and a second set of layers of image data and then horizontally blending the two sets of layers.

### SUMMARY OF THE INVENTION

The present invention provides a method for vertically blending more than two layers of image data, and it provides a method for horizontally blending layers of image data. This combination of horizontal and vertical blending has a variety of applications, a general application being the creation of a video employing both vertical blending of data sets to create a dynamic transparency effect and horizontal blending of the same data sets to create a lateral transition. A specific application would be the vertical blending of satellite imagery upon a terrain background and horizontally blending imagery across the day/night terminator. Blending two-dimensional data sets according to an exemplary method in accordance with invention includes vertically blending at least three layers of two-dimensional image data and assigning a variable transparency function to two-dimensional data within one of the layers. It may further include horizontally blending a first layer of image data and a second layer of image data.

### BRIEF DESCRIPTION OF THE DRAWINGS

The accompanying drawings, which are incorporated in and form a part of the specification, illustrate exemplary embodiments of the present invention and, together with the description, serve to explain the principles of the invention. In the drawings:

FIG. 1 illustrates potential vertically blending and horizontally blending in accordance with one embodiment of the present invention;

FIG. 2 illustrates an example of vertical blending in accordance with the present invention;

FIGS. 3A-3B illustrate another example of vertically blending in accordance with one embodiment of the present invention;

FIGS. 4A-4B an example of horizontal blending in accordance with the present invention;

FIGS. 5A-5F illustrate further examples of horizontal blending in accordance with the present invention;

FIGS. 6A-6D illustrate a day to night transition in a video created using horizontal blending in accordance with one embodiment of the present invention;

FIG. 7 is a flowchart of exemplary vertical blending and horizontal blending in accordance with one embodiment of the present invention;

FIGS. 8A and 8B illustrate an exemplary use of a weighting variable in horizontal blending in accordance With one embodiment of the present invention;

FIGS. 9A-9C illustrate further exemplary vertical blending and horizontal blending in accordance with one embodiment of the present invention; and

FIG. 10 is a flowchart of further exemplary vertical blending and horizontal blending in accordance with one embodiment of the present invention.

### DETAILED DESCRIPTION OF THE INVENTION

The present invention blends layers of two-dimensional image data, both horizontally and vertically. Image data may include any collection of image information used to form all or part of a layer of image data. A layer of image data (“layer”) may include any collection of two-dimensional image data.

Vertically blending two layers may include superimposing a first layer onto a second layer, wherein the first layer contains some transparency. The superimposition of these layers forms a “stack.” A stack is a single consolidated layer resulting from a vertically blended set of layers and therefore represents collective information from the ensemble of its component layers. When vertically blending an integer number n layers into a stack, the 1^{st} through n-1^{st} layers must have some transparency in order for the image data in the n^{th} layer to be viewed.

Unlike vertical blending, horizontal blending does not involve the superimposition of layers, but rather, the merging of layers. Horizontal blending of a first layer with a second layer to form a third layer may involve copying a portion of the first layer and a portion of the second layer to create the third layer.

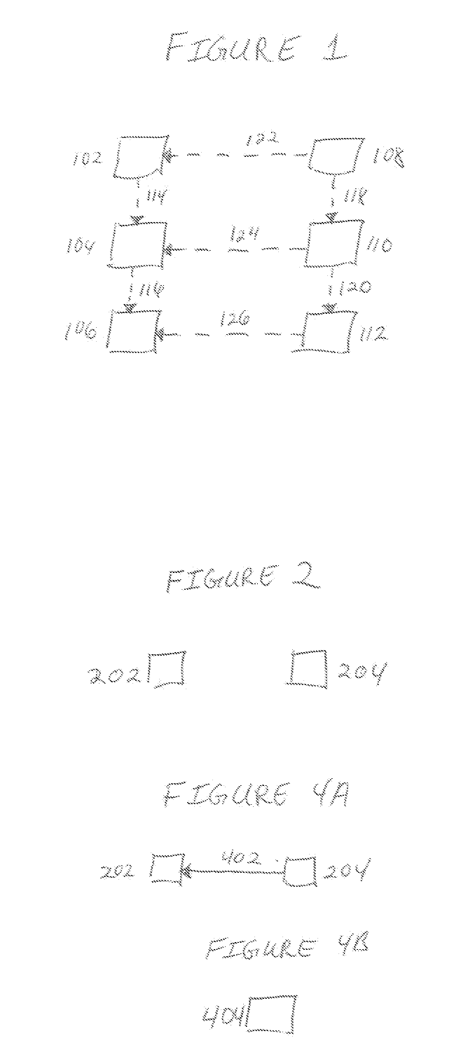

FIG. 1, schematically illustrates a plurality of layers 102, 104, 106, 108, 110, and 112. A first group of the plurality of layers 102, 104 and 106 may be vertically blended as illustrated by dotted lines 114 and 116. Similarly, a second group of the plurality of layers 108, 110 and 112 may be vertically blended as illustrated by dotted lines 118 and 120. Further, layer 108 may be horizontally blended with layer 102 as illustrated by dotted line 122, layer 110 may be horizontally blended with layer 104 as illustrated by dotted line 124, and layer 112 may be horizontally blended with layer 106 as illustrated by dotted line 126. As one of ordinary skill in the art would recognize from the present invention, any arrangement of vertical and horizontal blending my take place to arrive at a desired image data layer. For example, layer 110 may be horizontally blended 124 with layer 104 prior to layer 102 being vertically blended 114 with layer 104.

FIG. 2 illustrates one example of vertical blending, wherein stack 202 is a single consolidated layer resulting from vertically blending 114 and 116 layers 102, 104 and 106 and therefore represents collective information from the ensemble of layers 102, 104 and 106. Likewise, stack 204 is a single consolidated layer resulting from vertically blending 118 and 120 layers 108, 110 and 112 and therefore represents collective information from the ensemble of layers 108, 110 and 112. Any number of layers may be vertically blended in this fashion.

Typically, when a first layer is superimposed onto a second layer, parts of the first layer that are associated with no transparency will completely obscure parts of the second layer, thereby prohibiting a viewer from seeing the areas of the second layer (and any layers residing below the second layer) that are covered. In other areas, the first layer being superimposed onto the second layer may be assigned some non-zero transparency so a portion of the image data of both the first layer and the second layer may be viewed, i.e., they are “blended.” In still other areas, the first layer may be fully transparent, such that corresponding areas of the second layer may be viewed in their original form. Returning back to the example illustrated in FIG. 1, layers 102 and 104 must have some transparency in order for the image data in layer 106 to be viewed in stack 202. Similarly, layers 108 and 110 must have some transparency in order for the image data in layer 112 to be viewed in stack 204.

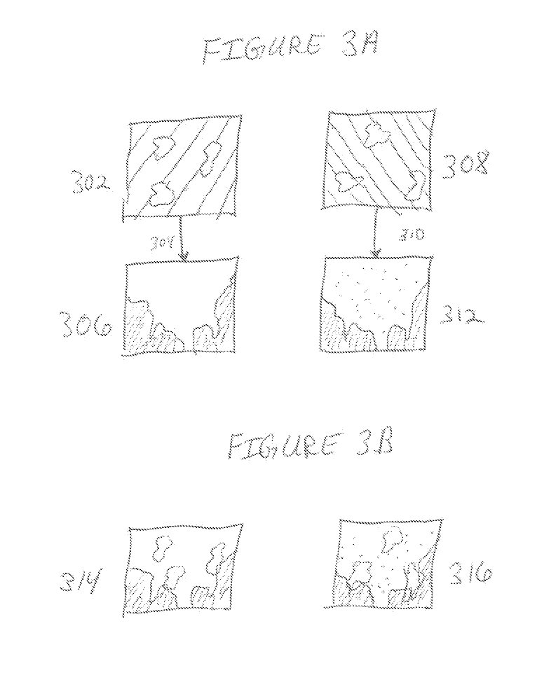

As discussed above, a stack is a single consolidated layer resulting from a vertically blended set of layers and therefore represents collective information from the ensemble of its component layers. For example, as illustrated in FIG. 3A, image data representing visible-channel satellite imagery of clouds during the day is shown in layer 302, whereas image data representing satellite imagery of the earth during the day is shown in layer 306. Layer 302 may be assigned an amount of transparency, and it may then be vertically blended 304 onto layer 306, producing a new layer illustrated in FIG. 3B representing the daytime terrain of the earth with clouds thereon in stack 314. Stack 314 is just one layer, even though it contains information from layer 302 and layer 306. Similarly, as illustrated in FIG. 3A, image data representing visible-channel satellite imagery of clouds during the night is shown in layer 308, whereas image data representing satellite imagery of the earth during the night is shown in layer 312. Layer 308 may be assigned an amount of transparency, and it may then be vertically blended 310 onto layer 312, producing a new layer illustrated in FIG. 3B representing the nighttime terrain of the earth with clouds thereon in stack 316. Stack 316 is just one layer, even though it contains information from layer 308 and layer 312.

Horizontal blending of layers to create a new horizontally blended layer may entail any method of blending layers together that results in a portion of image data from a first layer being present in a first portion of the new horizontally blended layer and a portion of image data from a second layer being present at another portion of the same new horizontally blended layer. The new horizontally blended layer represents horizontally blended image data.

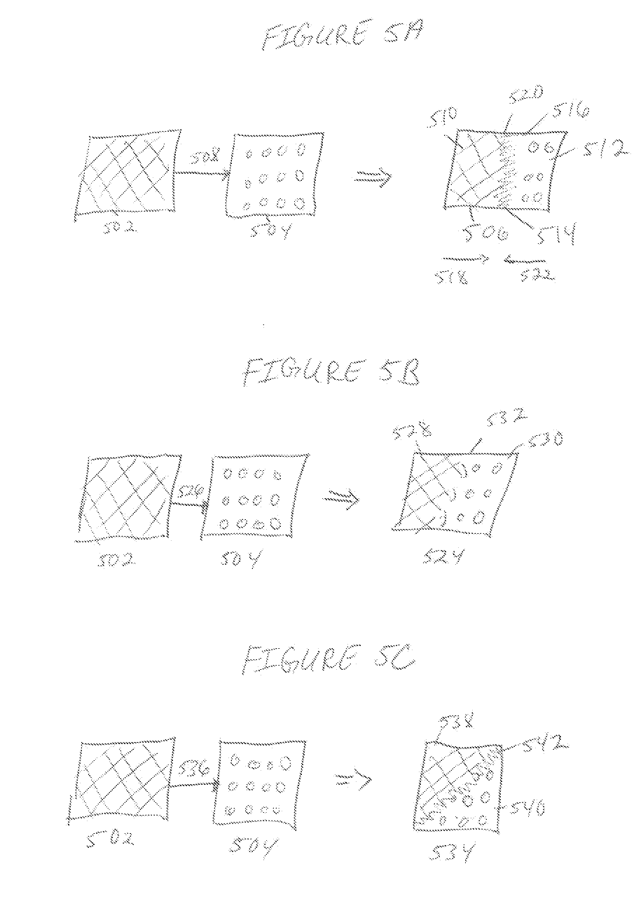

One embodiment of horizontal blending is schematically illustrated in FIGS. 4A and 4B. Stack 202 and stack 204 are horizontally blended 402, wherein a resulting stack 404 is a single layer comprising a portion of stack 202 and a portion of stack 204.

An area in the new horizontally blended image data where image data from the first layer transitions into image data from the second layer is called the “transition area.” The transition area may include a distinct demarcation between the first layer of data and the second layer. Alternatively, the transition area may be a type of soft data transition, wherein image data from the first layer is faded into image data from the second layer.

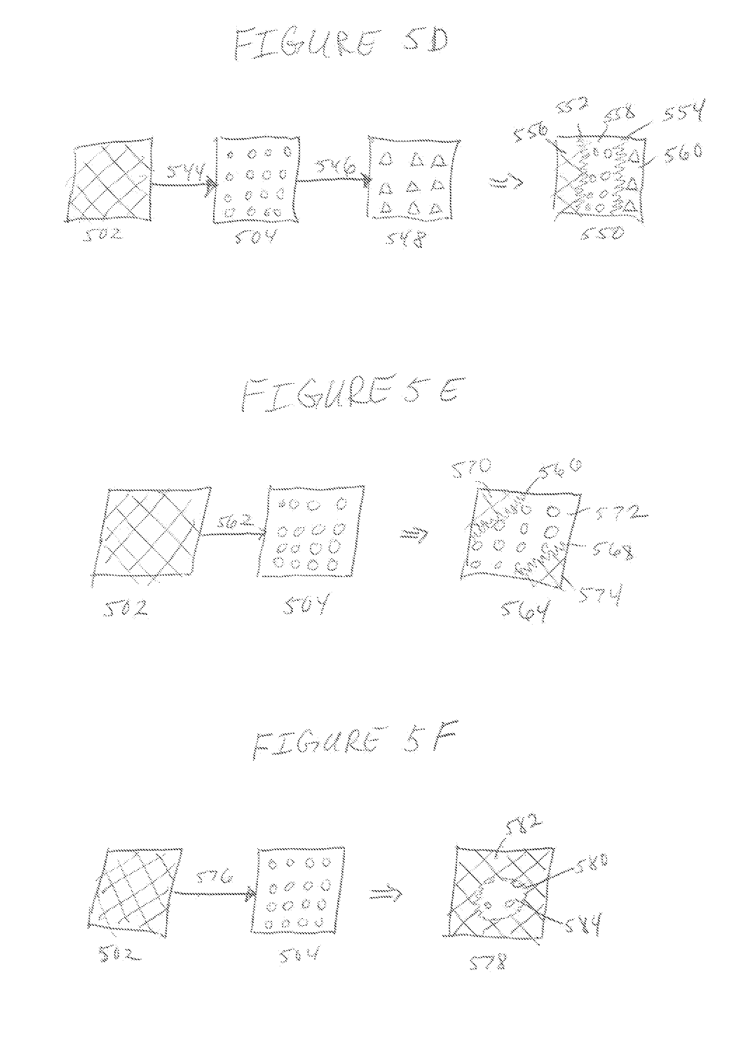

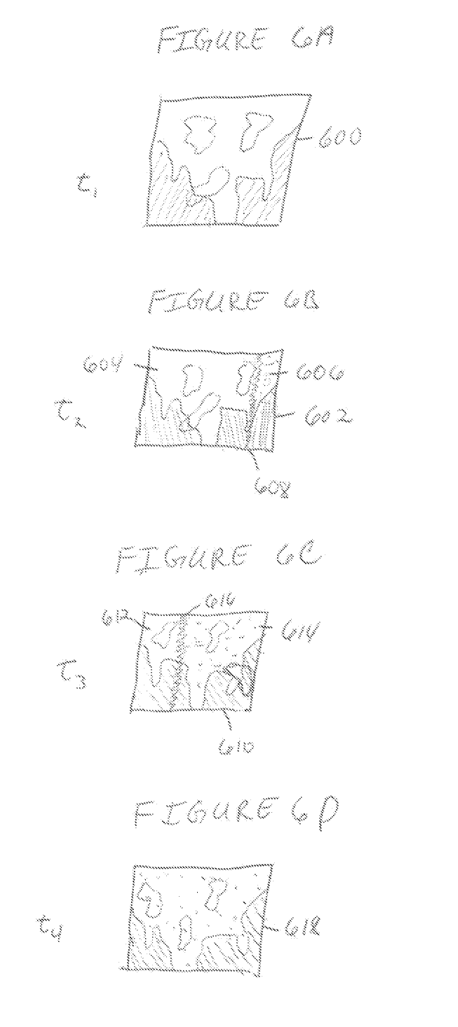

A gradual transition in accordance with an exemplary embodiment of the present invention is illustrated in FIG. 5A, wherein a layer 502 and a layer 504 are horizontally blended 508 creating the gradual fading effect seen in a new layer 506. A portion of image data 510 from layer 502 is present on one side of layer 506 and a portion of image data 512 from layer 504 is present on the opposing side of layer 506. Portion 510 and portion 512 are transitioned into each other in transition area 514.

In this example, image data from portion 510 gradually becomes more transparent within transition area 514 as it approaches an end 516 of the transition area from a first direction 518. Image data from portion 512 gradually becomes more transparent within the transition area 514 as it approaches an end 520 of the transition area from a second direction 522.

As briefly mentioned above, the horizontal blending of a first layer with a second layer may also occur abruptly at the transition area. The fading effect does not have to be present in order for two layers of image data to be horizontally blended. An example of one embodiment of the present invention illustrating abrupt blending is shown in FIG. 5B, wherein image data from layer 502 is horizontally blended 526 with image data from layer 504, creating a new layer 524. New layer 524 also includes a portion of image data 528 from layer 502, a portion of image data 530 from layer 504, and a transition area 532. In this example, transition area 532 is simply a demarcation where image data from one portion ends and image data from the other portion begins. Image data from layer 502 is represented on one side of transition area 532 and image data from layer 504 is represented on the other side of transition area 532. In this example, there is no fading effect like the one seen in layer 506 in FIG. 5A.

The transition area resulting from the blending of a first layer with a second layer may occur at any location on the image data of the new layer. An example of one embodiment of the present invention illustrating a transition area in a different location than the transition areas in FIGS. 5A and 5B is shown in FIG. 5C, wherein image data from layer 502 is horizontally blended 536 with image data from layer 504, resulting in a new layer 534. In layer 534, a transition area 542 is disposed diagonally between a portion of image data 538 from layer 502 and a portion of image data 540 from layer 504.

There may also be multiple transition areas when horizontally blending more than two layers of image data that result in a new layer of image data. An example of one embodiment of the present invention illustrating multiple transition areas resulting from horizontal blending of layers of image data is shown in FIG. 5D, wherein image data from layer 502 is horizontally blended 544 with image data from layer 504, which is horizontally blended 546 with image data from layer 548, resulting in a new layer 550. In this embodiment of the present invention, there are two transition areas, 552 and 554. At transition area 552, a portion of image data 556 from layer 502 transitions into a portion of image data 558 from layer 504. At transition area 554, portion 558 transitions into a portion of image data 560 from layer 548.

There may also be multiple transition areas from horizontally blending two layers that result in a new layer. A portion of image data from a first layer may be horizontally blended into a portion of image data from a second layer at a first transition area, and the portion of image data from the second layer may be horizontally blended into another portion of image data from the first layer at a second transition area. An example of one embodiment of the present invention illustrating horizontal blending with multiple transition areas between the same layers is illustrated in FIG. 5E. Layer 502 is horizontally blended 562 with layer 504 to form a new layer 564 resulting having two transition areas 566 and 568. Specifically, a portion of image data 570 from layer 502 is horizontally blended with a portion of image data 572 from layer 504 at transition area 566, and portion 572 is horizontally blended with a portion of image data 574 from layer 502 at transition area 568.

In another exemplary embodiment in accordance with the present invention, the transition area, resulting from the horizontal blending of a first layer with a second layer to form a new layer, is nonlinear. An example of one embodiment of the present invention illustrating horizontal blending of two layers of image data with a nonlinear transition area is illustrated in FIG. 5F, wherein image data from layer 502 is horizontally blended 576 with image data from layer 504, resulting in a new layer 578. In layer 578, the nonlinear transition area 580 is disposed between a portion of image data 582 from layer 502 and a portion of image data 584 from layer 504. Further image data from portion 582 may include a gradual fading, as discussed above, into image data from portion 584.

The above described exemplary embodiments of vertical blending schematically illustrated in FIG. 2 and horizontal blending schematically illustrated in FIGS. 4A-4B, merely suggest a manner of blending and are not intended to limit an order of blending. In particular, returning to FIG. 1, dotted lines 114, 116, 118 and 120 represent potential vertical blending procedures, whereas dotted lines 122, 124 and 126 represent potential horizontal blending procedures. As mentioned earlier, one of skill in the art would understand that layers 102, 104, 106, 108, 110 and 112 may be blended in any order, limited only in the desired end result of the user. Further, the invention is not limited to blending six layers. On the contrary, any number of layers may be blended using at least one of vertical and horizontal blending in accordance with the present invention.

Vertical and horizontal blending additionally may occur with video image data. For example, in a video, a transition area may appear to move. Specifically, a video may include a set of frames shown in succession, whereas a frame may include a representation of image data sampled at a certain point in time. As time goes on, each frame is shown in succession, and in each frame, the transition area may be located at a location different than the location of the transition area in the previous frame. This changing of frames creates the illusion that the transition area is moving.

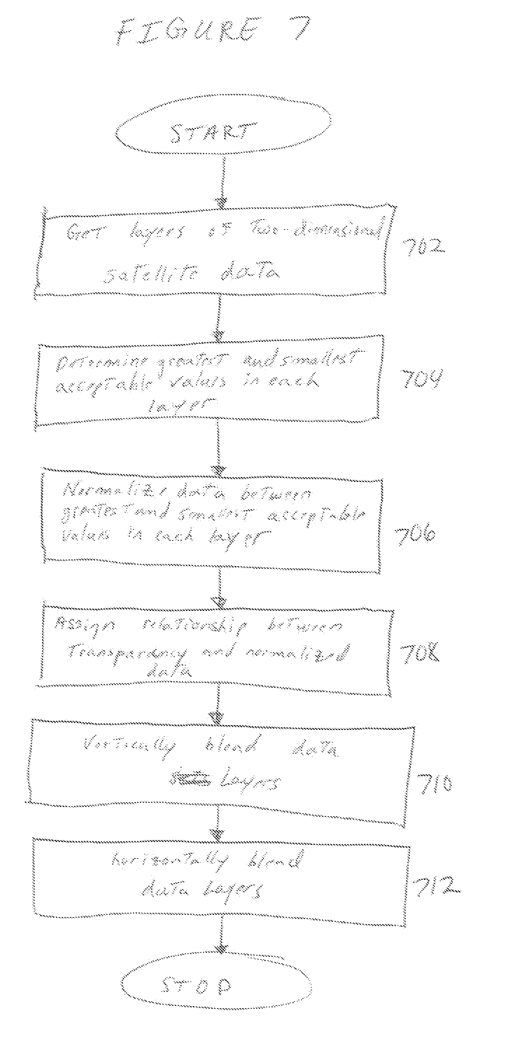

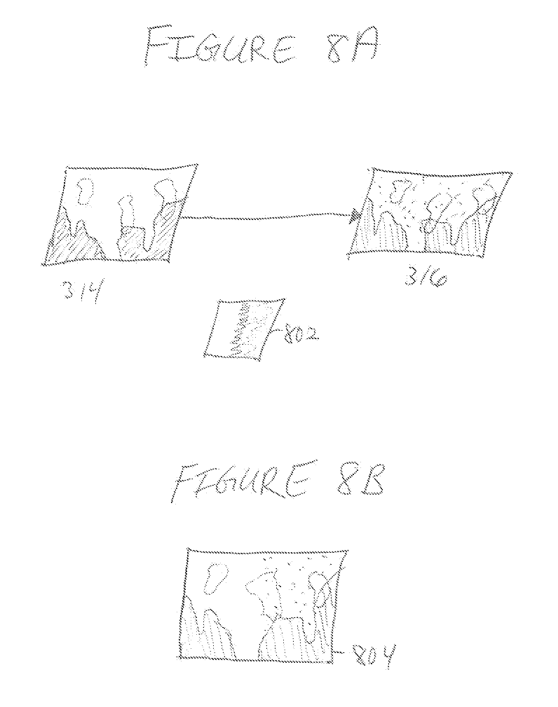

An example of one embodiment of this invention illustrating horizontal blending of two layers of is shown in FIG. 6A, wherein layer 600 represents a first frame in the video taken at time τ₁. This contains data representing satellite imagery of the earth at daytime. In FIG. 6B, layer 602 represents a second frame in the video taken at time τ₂. A portion 604 of layer 602 contains image data representing satellite imagery of the earth at daytime and a portion 606 of layer 602 contains image data representing satellite imagery of the earth at nighttime. Portion 604 and portion 606 are horizontally blended at transition area 608. In FIG. 6C, layer 610 represents a third frame in the video taken at time τ₃. A portion 612 of layer 610 contains data representing satellite imagery of the earth at daytime and a portion 614 of layer 610 contains data representing satellite imagery of the earth at nighttime. Portion 612 and portion 614 are horizontally blended at transition area 616.

In FIG. 6D, layer 618 represents a fourth frame in the video taken at time τ₄. Layer 618 contains data representing satellite imagery of the earth at nighttime. Showing the frames taken at τ₁, τ₂, τ₃, and τ₄ in succession will create the impression that the transition area is moving, and it will give the appearance that the image data in the video is transitioning from day to night. As the number of frames increase in succession, the transition area will appear to move at a smoother rate.

FIG. 7 illustrates an exemplary procedure for vertically and horizontally blending layers, in accordance with one embodiment of the present invention. To vertically blend layers, a plurality of layers is obtained 702. Any two-dimensional imagery digital format may be used with the present invention, non-limiting examples of which include bitmap, TIFF, GIF, PNG, etc.

When vertically blending layers, information in each layer may be conveyed in a single, vertically blended layer. Therefore, differences in each layer should be taken into account to be compared more effectively. For example, when vertically blending layers, one layer may contain information that is in some way more intense than information in another layer. For example, image data in one layer may be much brighter than image data in another layer. It may be left to the discretion of the designer as to the ordering of the layer, such that the most important information is place in the upper levels of the stack.

What is needed is a way to communicate to the viewer the relative information within each layer and the information of every layer simultaneously. Normalization helps communicate to the user the relative intensity of each data item within a layer. Once normalized, the layers may be given similar degree of transparency, even though information in one layer might be very distinct from information in other layers.

Layers are often very distinct. Normalizing data within each layer additionally allows the image data of each layer to be more effectively compared with the image data of the other layers. The smallest data value within a layer of image data represents the lowest intensity of the image data for that layer, whereas the greatest data value within a layer of image data represents the highest intensity of the image data for that layer. Some data values may be attributed to errors, whether created by detectors or subsequent processing, and such data values should not be included in the imagery. Therefore, user-defined, predetermined filters may be used to prevent data values that are too small or too great to be used in the imagery. After screening the data values that are too small or too great, the more important data values then become the smallest acceptable data value within the layer of image data, which will represents the lowest intensity of the image data for that layer, and the greatest acceptable data value within the layer of image data, which represents the highest intensity of the image data for that layer. Accordingly, the next step in an exemplary vertical blending procedure includes determining the smallest acceptable data value in each layer and the greatest acceptable data value in each layer 704. For example, the user may want a specific type of data value within the layer of data to be the least transparent part of the image. For example, in the layer 302 representing visible satellite imagery of cloud data, the greatest value would be the area where the cloud is the densest, i.e., where the cloud is the “whitest,” and therefore the least transparent. Likewise, in infrared satellite imagery, the coldest values often correspond to the highest, most opaque clouds. In this case, the infrared imagery would be scaled such that the coldest values corresponded to the smallest values of transparency.

In an exemplary embodiment in accordance with the present invention, the data within each layer is then normalized between the smallest acceptable data value the greatest acceptable data value 706. Image data within a layer that has a value that is closer to the greatest acceptable data value may be set to be more opaque, and image data within that same layer that has a value that is closer to the smallest acceptable data value may be set to be more transparent. Any desired normalization method may be used, non-limiting examples of which include linear and non-linear normalization between the smallest acceptable data value and the greatest acceptable data value.

If normalized, then a relationship between transparency and the normalized data is established 708. For example, a decision may be made to set image data with a normalized value of 0 to be opaque and to set image data with a normalized value of 1 to be completely transparent. With such a decision, a linear scaling applied to data values ranging between 0 and 100 would map a data value of 25 to a transparency factor of 0.25, a data value 50 to a transparency factor of 0.5, and a data value 75 to a transparency factor of 0.75. A non-linear scaling applied to this same data range, on the other hand, might have mapped a data value of 25 to a transparency factor of 0.1, a data value of 50 to a transparency factor of 0.35, and a data value of 75 to a transparency factor of 0.80 (i.e. ramping up quickly at the end), or vice versa.

A layer of image data may then be vertically blended, as discussed above with another layer of image data 710. In an exemplary working embodiment, this vertical blending is accomplished with the following formula for M layers (C represents the values for red, green, and blue, and the layers are represented by N):

$$C = ( {N}_{1} + ( 1.0 - {N}_{1} ) ( {N}_{2} + ( 1.0 - {N}_{2} ) [ … ( {N}_{M - 1} + ( 1.0 - {N}_{M - 1} ) {N}_{M} ) ) ) ] .$$

As mentioned above, horizontal blending of image data with a second layer to form a third layer 712 may involve copying a portion of the first layer and a portion of the second layer to create the third layer.

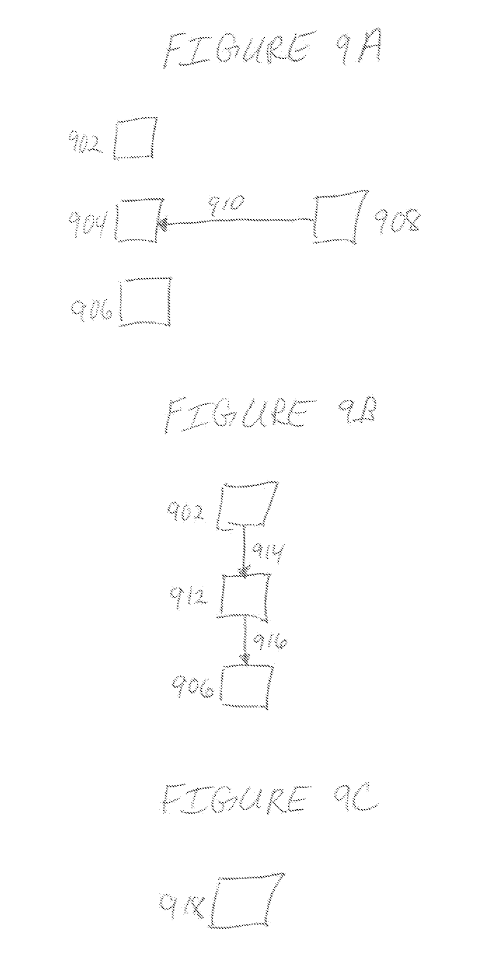

In horizontal blending, a weight variable is assigned to set the degree of transition between the layers. One embodiment of the present invention is shown in FIG. 8A, layer 314 is horizontally blended into layer 316 according to an equation taking this weight variable into account, represented by 802. The result layer 804 of the horizontal blending in this example is shown in FIG. 8B.

Any specific equation may be used to describe horizontal blending containing a weight variable. In an exemplary embodiment of the present invention, the following formula is used:

C=W_{xy}(Sₓ)+(1.0−W_{xy})^{A}(S_{y})

Here, W_{xy} represents the weight variable and S represents a stack of data. Note that a data stack may be composed of only one layer. Exponent term A represents the transition weight, and C represents the color components of the image, in red, green, and blue. Note that the transition weight does not have to be linear. Changing the value of A to 2, for example, will produce a transition that is nonlinear. By altering the variables in the above equation, the layers of image data may be set to transition more sharply or more smoothly into each other. The point is that either or both of the horizontal blending terms and vertical transparency may be non-linear. However, it would be apparent to those of skill in the art that any specific relation to determine transparency of image data may be used.

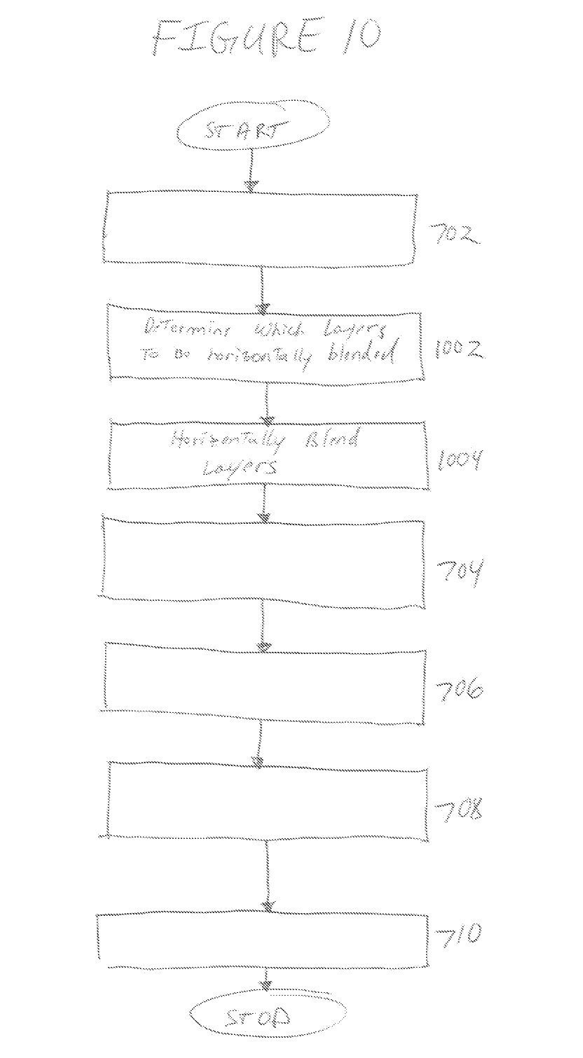

As illustrated in FIGS. 9A-9C, horizontal blending may take place prior to vertical blending. As illustrated in FIG. 9A, layer 908 is horizontally blended 910 into layer 904, to form a new horizontally blended layer 912. Then, as illustrated in FIG. 9B, layer 902, layer 912 and layer 906 are vertically blended 914 and 916 with one another. The resulting horizontally and vertically blended layer 918 illustrated in FIG. 9C, is actually a stack of layers 902, 912 and 906.

FIG. 10 illustrates another exemplary procedure for vertically and horizontally blending two-dimensional image data, in accordance with another embodiment of the present invention. Steps 702, 704, 706, 708, and 710 are the same as those illustrated in FIG. 7. The difference between the procedure of FIG. 10 from the procedure of FIG. 7 is that horizontal blending is performed prior to vertical blending in the procedure of FIG. 10. In step 1002, the layers to be horizontally blended are determined. For example, as illustrated in FIG. 9, it is determined that layers 908 and 904 are to be horizontally blended. In step 1004, the layers are horizontally blended. For example, as illustrated in FIG. 9, layers 908 and 904 are horizontally blended 910 to create layer 912. The remaining steps of FIG. 10 vertically blend layers 902, 912 and 906 to create layer 918.

The data to be used with the present invention is not limited to satellite image data. On the contrary, any image data may be used, non-limiting examples of which include, geographic data, marketing data, graphical data, etc.

The invention may be implemented as hardware, such as for example a computer system. Further, the invention may be implemented as software, such as for example a computer readable media having stored thereon, computer readable instructions operable to instruct a computer to perform functions. Still further, the invention may be implemented as a computer readable signal having therein, computer readable instructions operable to instruct a computer to perform functions. Finally the invention may be implemented as a combination of hardware, software, and signal components.

In the case where the invention is implemented as hardware, it may be a unitary device that is operable to perform each of exemplary steps 702, 704, 706, 708, 710, 712, 1002 and 1004. Alternatively, it may be a plurality of devices, each operable to perform at least one of exemplary steps 702, 704, 706, 708, 710, 712, 1002 and 1004. Further, in a case where the invention is implemented as software, it may be a single computer readable media having computer readable instructions stored thereon that are operable to instruct a computer to perform each of exemplary steps 702, 704, 706, 708, 710, 712, 1002 and 1004. Alternatively, it may be a plurality of computer readable media, each having computer readable instructions stored thereon that are operable to instruct a computer to perform at least one of exemplary steps 702, 704, 706, 708, 710, 712, 1002 and 1004. Still further, in the case where the invention is implemented as a computer readable signal, it may be a unitary signal that is operable to instruct a computer to perform each of exemplary steps 702, 704, 706, 708, 710, 712, 1002 and 1004. Alternatively, it may be a plurality of signals, each having computer readable instructions therein that are operable to instruct a computer to perform at least one of exemplary steps 702, 704, 706, 708, 710, 712, 1002 and 1004. As alluded to above, any one of exemplary steps 702, 704, 706, 708, 710, 712, 1002 and 1004 may be performed by a combination of hardware, software, and signal components.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method comprising:
vertically blending n layers of two-dimensional image data; and
assigning a variable transparency function to each of a first through n-1^{th} layers, respectively, of the n layers of two-dimensional image data,
wherein n is an integer greater than 2.

2. A method comprising:
vertically blending two layers of two-dimensional image data;
assigning a variable transparency function to one of the two layers of two-dimensional image data; and
horizontally blending another layer of two-dimensional image data to one of the two layers of two-dimensional image data.

3. The method according to claim 2, further comprising:
determining a highest acceptable value data within the image data within the one of the two layers of two-dimensional image data;
determining a lowest acceptable value data within the image data within the one of the two layers of two-dimensional image data; and
normalizing the two-dimensional image data within the one of the two layers of two-dimensional image data between the highest acceptable value data and the lowest acceptable value data.

4. The method according to claim 3, wherein said normalizing comprises applying a linear scaling to the two-dimensional image data.

5. The method according to claim 3, wherein said normalizing comprises applying a non-linear scaling to the two-dimensional image data.

6. An apparatus comprising:
a vertical blending component operable to blend n layers of two-dimensional image data; and
an assigning component operable to assign a variable transparency function to each of a first through n-1^{th} layers, respectively, of the n layers of two-dimensional image data
wherein n is an integer greater than 2.

7. An apparatus comprising:
a vertical blending component operable to blend two layers of two-dimensional image data;
an assigning component operable to assign a variable transparency function to one of the two layers of two-dimensional image data; and
a horizontal blending component operable to horizontally blend another layer of two-dimensional image data to one of the two layers of two-dimensional image data.

8. The apparatus according to claim 7, further comprising:
a first determination component operable to determine a highest acceptable value data within the image data within the one of the two layers of two-dimensional image data;
a second determination component operable to determine a lowest acceptable value data within the image data within the one of the two layers of two-dimensional image data; and
a normalization component operable to normalize the two-dimensional image data within the one of the two layers of two-dimensional image data between the highest acceptable value data and the lowest acceptable value data.

9. The apparatus according to claim 8, wherein normalization component is operable to apply a linear scaling to the two-dimensional image data.

10. The apparatus according to claim 8, wherein said normalization component is operable to apply a non-linear scaling to the two-dimensional image data.

11. A computer readable medium, having stored thereon, computer readable instructions operable to instruct a computer to perform a method comprising:
vertically blending n layers of two-dimensional image data; and
assigning a variable transparency function to each of a first through n-1^{th} layers, respectively, of the n layers of two-dimensional image data,
wherein n is an integer greater than 2.

12. A computer readable medium, having stored thereon, computer readable instructions operable to instruct a computer to perform a method comprising:
vertically blending two layers of two-dimensional image data;
assigning a variable transparency function to one of the two layers of two-dimensional image data; and
horizontally blending another layer of two-dimensional image data to one of the two layers of two-dimensional image data.

13. The computer readable medium according to claim 12, having stored thereon, computer readable instructions operable to instruct a computer to perform the method further comprising:
determining a highest acceptable value data within the image data within the one of the two layers of two-dimensional image data;
determining a lowest acceptable value data within the image data within the one of the two layers of two-dimensional image data; and
normalizing the two-dimensional image data within the one of the two layers of two-dimensional image data between the highest acceptable value data and the lowest acceptable value data.

14. The computer readable medium according to claim 13, having stored thereon, computer readable instructions operable to instruct a computer to perform the method, wherein said normalizing comprises applying a linear scaling to the two-dimensional image data.

15. The computer readable medium according to claim 13, having stored thereon, computer readable instructions operable to instruct a computer to perform the method, wherein said normalizing comprises applying a non-linear scaling to the two-dimensional image data.

16. A signal, having stored thereon computer readable instructions operable to instruct a computer to perform a method comprising:
vertically blending n layers of two-dimensional image data; and
assigning a variable transparency function to each of a first through n-1^{th} layers, respectively, of the n layers of two-dimensional image data.
wherein n is an integer greater than 2.

17. A signal, having stored thereon, computer readable instructions operable to instruct a computer to perform a method comprising:
vertically blending two layers of two-dimensional image data;
assigning a variable transparency function to one of the two layers of two-dimensional image data; and
horizontally blending another layer of two-dimensional image data to one of the two layers of two-dimensional image data.

18. The signal according to claim 17, having stored thereon, computer readable instructions operable to instruct a computer to perform the method further comprising:
determining a highest acceptable value data within the image data within the one of the two layers of two-dimensional image data;
determining a lowest acceptable value data within the image data within the one of the two layers of two-dimensional image data; and
normalizing the two-dimensional image data within the one of the two layers of two-dimensional image data between the highest acceptable value data and the lowest acceptable value data.

19. The signal according to claim 18, having stored thereon, computer readable instructions operable to instruct a computer to perform the method, wherein said normalizing comprises applying a linear scaling to the two-dimensional image data.

20. The signal according to claim 18, having stored thereon, computer readable instructions operable to instruct a computer to perform the method, wherein said normalizing comprises applying a non-linear scaling to the two-dimensional image data.
